(19) United States
(12) Patent Application Publication
(10) Pub. No.: US 2008/0008216 A1
(43) Pub. Date: Jan. 10, 2008

(54) Laser device including heat sink with insert to provide a tailored coefficient of thermal expansion

(75) Inventors: Robert L. Miller, Tucson, AZ (US); Raman Srinivasan, Tucson, AZ (US)

Correspondence Address: ORION LAW GROUP, 3 HUTTON CENTRE, SUITE 850, SANTA ANA, CA, 92707, US

(73) Assignee: Newport Corporation, Irvine, CA (US)

(21) Appl. No.: 11/482,267

(22) Filed: Jul. 7, 2006

(51) Int. Cl. H01S 3/04

(52) U.S. Cl. 372/36; 372/34

(57) ABSTRACT

A laser module comprising a laser device attached to a heat sink that is configured to provide a relatively low thermal resistance for thermal management of the laser device, and a coefficient of thermal expansion (CTE) that is substantially matched to the CTE of the laser device for reducing stress caused by thermal cycles. The heat sink includes a shell made out of a first material, and an insert situated within the shell and made out of a second material distinct from the first material of the shell. By properly selecting the first and second materials, configuring the overall mass of the shell with respect to the overall mass of the insert, and positioning, arranging, and/or orienting the insert with respect to the laser device, the desired effective thermal resistance and CTE for the heat sink may be achieved. In one embodiment, the shell includes a material, such as copper, or a metal matrix composite such as copper graphite. The insert includes a thermal pyrolytic graphite oriented such that its x-axis extends substantially parallel to the longitudinal axis of the laser device, and its y-axis extends substantially perpendicular to the laser device.

### BACKGROUND

Laser devices, such as semiconductor lasers, are used in many applications, such as medical, imaging, ranging, welding, cutting, and many other applications. Some of these are low power applications, and others are high power applications. In high power applications, semiconductor lasers are exposed to relatively high temperatures. High temperatures on semiconductor lasers may cause damage to the devices, and typically reduce their performance characteristics including their expected operational life. Accordingly, heat sinks are typically provided with semiconductor lasers for thermal management purposes. This is better explained with reference to the following example.

FIG. 1 illustrates a side view of an exemplary conventional laser module 100. The laser module 100 consists of a laser device 102, such as a gallium-arsenide (GaAs) semiconductor laser device, and a heat sink 104 typically made of a relatively high thermal conductivity material, such as copper (Cu). The GaAs laser device 102 is attached to the Cu heat sink 104 via a bonding material 106, such as solder. The Cu material, which has a relatively high thermal conductivity of approximately 380 Watts per meter Kelvin (W/mK), serves as an adequate thermal management tool for the semiconductor laser device 102. However, as discussed below, there are also adverse issues associated with the use of the Cu heat sink 104.

In relatively high power applications, continuous wave (CW) or pulsed applications, the laser module 100 may be subjected to relatively high temperatures. Additionally, the laser module 100 may also be subjected to frequent thermal cycles, between room temperature and the high operating temperatures of the device. Because of the substantially difference in the coefficients of thermal expansion (CTE) of GaAs (e.g., approximately 6.5 parts per million per degree Kelvin (ppm/C)) and Cu (e.g., approximately 17 ppm/C), the thermal cycle that the laser module 100 undergoes creates substantial stress on the GaAs laser device 102 and the Cu heat sink 104. Such stress may cause cracks in the laser device 102, which may, in turn, cause the device to fail.

To alleviate this problem, the bonding material 106 is generally made out of a soft solder, such as Indium-based solders. Soft solders are typically used as the bonding material 106 because they have a relatively low melting temperature and have the ability to creep. Their creeping ability allows the soft solder to absorb some of the stress that develop on the laser device 102 as a result of thermal cycles. However, it has been observed that intermetallic compounds formed during the bonding process with soft solders lead to solder fatigue and, ultimately, to premature failure. Additionally, in a pulsing operational mode of the laser device 102, it has been observed that electromechanical solder migration occurs in soft solders.

Harder solders, such as gold-tin (AuSn), may be used as the bonding material 106 because they are less susceptible to thermal fatigue than soft solders, and have high strength that result in elastic rather than plastic deformation. However, AuSn solder is not generally a good candidate for the bonding material 106 because they do not have the creeping properties that soft solders have, and thus, the hard solder does not absorb well the stress developed on the laser device 102 during thermal cycling.

### SUMMARY

An aspect of the invention relates to a laser module comprising a laser device attached to a heat sink. The heat sink is configured to provide a relatively low thermal resistance for thermal management of the laser device. The heat sink is also configured to provide a coefficient of thermal expansion (CTE) that is substantially matched to the CTE of the laser device. In particular, the heat sink comprises a shell made out of a first material. The substrate includes one or more inserts situated within the shell, and comprised of a second material distinct from the first material of the substrate. By properly selecting the first and second materials, configuring the overall mass of the shell with respect to the overall mass of the one or more inserts, and positioning, arranging and/or orienting the one or more inserts, the desired effective thermal resistance and CTE for the heat sink may be achieved. As an example, the shell comprises a material, such as copper, or a metal matrix composite such as copper graphite. The insert includes a material, such as diamond or a thermal pyrolytic graphite. The thermal pyrolytic graphite may be oriented such that its x-axis extends substantially parallel to the longitudinal axis and its y-axis extends perpendicular to the longitudinal axis of the laser device.

In one embodiment, the CTE of the shell is greater than the CTE of the laser device. Accordingly, to decrease the effective CTE of the heat sink from that of the shell towards the CTE of the laser device, the CTE of the insert is less than the CTE of the laser device. In another embodiment, the CTE of the shell is less than the CTE of the laser device. Accordingly, to increase the effective CTE of the heat sink from that of the shell towards the CTE of the laser device, the CTE of the insert is greater than the CTE of the laser device. With reference to both embodiments, by properly selecting the shell and insert materials, determining the size (and quantity) of the insert, and position, arrangement, and/or orientation of the insert with respect to the laser device, the desired effect thermal resistance for thermal management and the desired CTE for stress reduction may be achieved.

Other aspects, advantages and novel features of the present invention will become apparent from the following detailed description of the invention when considered in conjunction with the accompanying drawings.

### BRIEF DESCRIPTION OF THE DRAWINGS

FIG. 1 illustrates a side view of an exemplary conventional laser module including a heat sink for thermal management;

FIG. 2A illustrates a side cross-sectional view of an exemplary laser module in accordance with an embodiment of the invention;

FIG. 2B illustrates a side cross-sectional view of another exemplary laser module in accordance with an embodiment of the invention; and

FIG. 3 illustrates a perspective view of an exemplary insert for a heat sink in accordance with another embodiment of the invention.

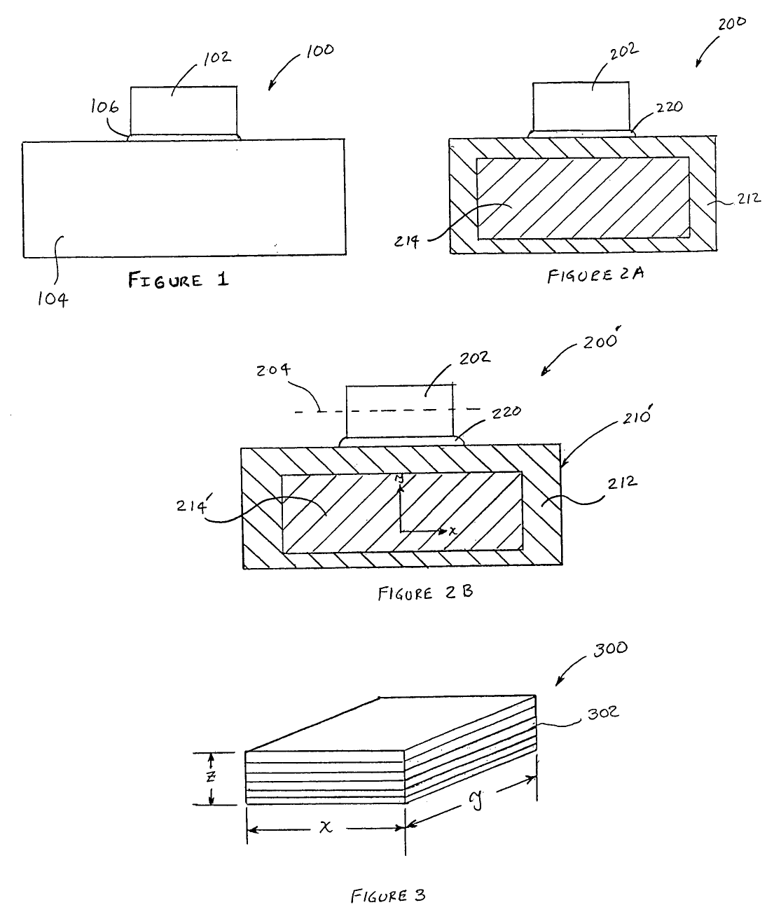

### DETAILED DESCRIPTION

FIG. 2A illustrates a side cross-sectional view of an exemplary laser module 200 in accordance with an embodiment of the invention. The laser module 200 comprises a laser device 202, a heat sink 210, and a bonding material 220 for securely attaching the laser device 202 to the heat sink 210. The heat sink 210, in turn, comprises a shell 212 and one or more inserts 214 situated within the shell 212. In this example, the bonding material 220 (e.g., solder or epoxy) attaches the laser device 202 to the top of the shell 212.

More specifically, the laser device 202 may be any type of laser device mountable on a heat sink. For example, the laser device 202 may be a semiconductor laser diode or other type of laser device. Some specific examples of semiconductor laser devices include galium-arsenide (GaAs) lasers, indium-phosphide (InP) lasers, and others. For the purpose of discussing the exemplary embodiment of the heat sink 210, the GaAs semiconductor laser serves as the particular example. However, it shall be understood that the invention is not limited to a GaAs semiconductor laser, and encompasses other types of lasers as discussed above.

The heat sink 210 achieves at least a couple of objectives. First, the heat sink 210 acts as a relatively low thermal resistance device for thermal management of the laser device 202. Second, the heat sink 210 has an effective coefficient of thermal expansion (CTE) that is substantially matched with the CTE of the laser device 202 such that stress developed on the laser device 202 during thermal cycling and bonding is substantially reduced. In accordance with these aims, the selection of the materials for the shell 212 and the insert 214 is such that the heat sink 210 has a relatively low thermal resistance and has an effective CTE that is substantially matched with the CTE of the laser device 202.

As an example, for the purpose of providing a relatively low thermal resistance for the heat sink 210, the shell 212 may be comprised of a relatively high thermal conductive material, such as copper (Cu), a metal matrix composite such as copper graphite, and other high thermal conductive materials. For example, copper graphite has a thermal conductivity of approximately 220 to 200 W/mK in the x-y orientation.

In addition, the insert 214 should also have a relatively high thermal conductivity, such as diamond and other high thermal conductive materials. As shown in FIG. 2B, a modified laser module 200′ includes a modified heat sink 210′ comprising a thermal pyrolytic graphite, whose thermal property vary with the orientation of the material. For example, thermal pyrolytic graphite has a thermal conductivity of approximately 1500 W/mK in the x-y orientation. That is, the x-direction of the thermal pyrolytic graphite should extend substantially parallel to the longitudinal axis 204 of the laser device 202 and the y-axis of the thermal pyrolytic graphite should extend substantially perpendicular to the longitudinal axis 204 of the laser device 202 to provide a low thermal resistance. In the z-direction, the thermal pyrolytic graphite acts as a thermal insulator, which is not generally suitable for heat sink applications.

For the purpose of substantially matching the effective CTE of the heat sink 210 to the CTE of the laser device 202, a number of parameters should be properly selected, including the selection of the materials for the shell 212 and the insert 214, the mass of the shell 212 with respect to the mass of the insert 214, the orientation of the shell 212 and insert 214 if they are materials whose expansion properties depend on orientation, and the position of the insert 214 within the shell 212 and with respect to the laser device 202.

As an example, the CTE of a GaAs laser device 202 may be approximately 6.5 ppm/C. The CTE of a copper graphite shell 212 may be approximately 7 (x-y) ppm/C. To lower the 7 (x-y) ppm/C CTE of the copper graphite shell 212, a particular sized thermal pyrolytic graphite insert 214 may be inserted within a pre-defined cavity of the shell 212. Since the CTE of the thermal pyrolytic graphite insert 214 is relatively low, and could even have a negative CTE, the effective CTE of the heat sink 210 can be configured such that it is substantially matches the CTE of the GaAs laser device 202.

The GaAs laser device 202, the copper graphite shell 212, and the thermal pyrolytic graphite insert 214 are merely examples of a particular configuration for the laser module 200. It shall be understood that the materials for the shell 212 and the insert 214 may vary substantially, depending on the material of the laser device 202, the desired thermal resistance for the heat sink 210, and the desired matching of the effective CTE for the heat sink 210 with the CTE of the laser device 202.

In general, the selection of the material for the insert 214 should be designed to “move” the effective CTE of the heat sink 210 from the CTE of the shell 212 towards the CTE of the laser device 202. In the above example, the “movement” was in the negative direction (e.g., from the 7 (x-y) ppm/C of the copper graphite shell 212 towards the 6.5 ppm/C of the laser device 202). It shall be understood that the movement may be in the positive direction, as in the case where the shell 212 has a CTE lower than the CTE of the laser device 202, and the insert 214 has a CTE higher than the CTE of the laser device 202.

FIG. 3 illustrates a perspective view of an exemplary insert 300 for a heat sink in accordance with another embodiment of the invention. The exemplary insert 300 may be a particular example of the insert 214 for the heat sink 210 discussed above. In this example, the insert 300 has thermal and/or expansion properties that depend on the orientation of the insert, such as thermal pyrolytic graphite. It shall be understood that the shell 212 discussed above can be comprised of a material whose thermal and/or expansion properties depend on orientation, such as a metal matrix composite like copper graphite.

The insert 300 may be an example of a thermal pyrolytic graphite material. The pytolytic graphite insert 300 is formed of a plurality of layers of carbon monotube arrays 302 in a stacked relationship. In this example, the thermal pyrolytic graphite insert 300 is configured as a cubic or rectangular solid having the three Cartesian axes, x-, y-, and z-. It shall be understood that the configuration of the thermal pyrolytic graphite insert 300 may take forms, such as a disk, trapezoid, etc.

As discussed above, the properties of the thermal pyrolytic graphite insert 300 depends on the orientation of the insert. For example, in a direction parallel to the layers 302, such as in the x-, y-, and x-y directions, the thermal pyrolytic graphite insert 300 exhibits a significantly high thermal conductivity of approximately 1500 W/mK. Also, in these directions, the CTE of the thermal pyrolytic graphite insert 300 is very low, and can even have negative values (i.e., it shrinks with elevated temperatures). Thus, it can be strategically combined with a copper shell 212 or a copper graphite shell 212 to form a heat sink 210 that has an effective CTE substantially matched with the CTE of, for example, a GaAs semiconductor laser 202.

As discussed above, the metal matrix composite, copper graphite, serving as a shell, also has thermal and expansion properties that depend on the orientation of the material. For example, in the x-y direction (i.e., along the layer), the copper graphite material exhibits a relatively high thermal conductivity of approximately 275 to 300 W/mK, and has a CTE of approximately seven (7) ppm/C. In the z-direction (i.e., orthogonal to the x- and y-axes), the material exhibits a thermal conductivity of 220 to 230 W/mK and a CTE of 16 ppm/C.

Accordingly, with regard to this material, thermal pyrolytic graphite, the material may be oriented such that the x-direction extends in a direction substantially parallel to the longitudinal axis 204 of the laser device 202, and the y-direction is substantially perpendicular to the longitudinal axis 204 of the laser device, as shown in FIG. 2B. This allows the material to exhibit a relatively low thermal resistance for the laser device 202, and also exhibits a relatively low CTE so that the effective CTE of the heat sink 210 may be substantially matched to the CTE of the laser device 202. This would be provide a heat sink 210 exhibiting a relatively low thermal resistance for thermal management of the laser device 202, and an effective CTE that is substantially matched to the CTE of the laser device 202 to reduce stress on the device 202 during thermal cycling.

While an improved laser module device with improved heat sink is disclosed by reference to the various embodiments and examples detailed above, it should be understood that these examples are intended in an illustrative rather than limiting sense, as it is contemplated that modifications will readily occur to those skilled in the art which are intended to fall within the scope of the present invention.

What is claimed is:

1. A laser module, comprising:
a laser device; and
a heat sink to which said laser device is attached, wherein said heat sink comprises:
a shell comprised of a first material;
an insert situated within said shell, wherein said insert comprises a second material distinct from said first material of said shell; and
wherein an effective CTE of said heat sink is substantially matched with a CTE of said laser device.

2. The laser module of claim 1, wherein said laser device comprises a semiconductor laser.

3. The laser module of claim 2, wherein said laser device comprises GaAs, InP, or any combination thereof.

4. The laser module of claim 1, wherein said first material of said shell comprises a metal matrix composite.

5. The laser module of claim 4, wherein said metal matrix composite comprises a copper graphite material.

6. The laser module of claim 4, wherein an x-, y- or x-y axis of said metal matrix composite extends in a direction generally towards said laser device.

7. The laser module of claim 1, wherein said first material of said shell comprises a material having a thermal and/or expansion property dependent on an orientation of said first material.

8. The laser module of claim 7, wherein said first material of said shell is oriented in a manner to substantially reduce an effective thermal resistance of said heat sink.

9. The laser module of claim 1, wherein said first material of said shell comprises copper, copper graphite, or any combination thereof.

10. The laser module of claim 1, wherein said second material of said insert comprises a material having a thermal and/or expansion property dependent on an orientation of said second material.

11. The laser module of claim 10, wherein said second material of said insert is oriented in a manner to substantially reduce an effective thermal resistance of said heat sink.

12. The laser module of claim 1, wherein said second material of said insert comprises thermal pyrolytic graphite.

13. The laser module of claim 12, wherein an x-axis direction of said thermal pyrolytic graphite extends substantially parallel to a longitudinal axis of said laser device, and a y-axis direction of said thermal pyrolytic graphite extends substantially perpendicular to said longitudinal axis of said laser device.

14. The laser module of claim 1, wherein said second material of said insert comprises thermal pyrolytic graphite, diamond, or any combination thereof.

15. The laser module of claim 1, wherein said heat sink further comprises a plurality of inserts situated within said shell.

16. The laser module of claim 1, further comprising a bonding material for attaching said laser device to said heat sink.

17. The laser module of claim 16, wherein said bonding material comprises a solder or epoxy.

18. A laser module, comprising:
a laser device having a first CTE; and
a heat sink to which said laser device is attached, wherein said heat sink comprises:
a shell comprised of a first material having a second CTE;
an insert situated within said shell, wherein said insert comprises a second material having a third CTE; and
wherein said second CTE is greater than said first CTE, and wherein said third CTE is less than said first CTE.

19. The laser module of claim 18, wherein an effective CTE of said heat sink is substantially matched with said first CTE of said laser device.

20. A laser module, comprising:
a laser device having a first CTE; and
a heat sink to which said laser device is attached, wherein said heat sink comprises:
a shell comprised of a first material having a second CTE;
an insert situated within said shell, wherein said insert comprises a second material having a third CTE; and
wherein said second CTE is less than said first CTE, and wherein said third CTE is greater than said first CTE.

21. The laser module of claim 20, wherein an effective CTE of said heat sink is substantially matched with said first CTE of said laser device.
